(19) United States
(12) Patent Application Publication
(10) Pub. No.: US 2007/0019251 A1
(43) Pub. Date: Jan. 25, 2007

(54) Double-side image scanning method and device

(75) Inventor: Chun-Chieh Liao, Hsinchu City (TW)

Correspondence Address: BIRCH STEWART KOLASCH & BIRCH, PO BOX 747, FALLS CHURCH, VA, 22040-0747, US

(73) Assignee: Avision Inc., Hsinchu (TW)

(21) Appl. No.: 11/486,018

(22) Filed: Jul. 14, 2006

(30) Foreign Application Priority Data
Jul. 15, 2005 (TW) 094124037

(51) Int. Cl. H04N 1/04

(52) U.S. Cl. 358/474

(57) ABSTRACT

A double-side image scanning method and device is provided, wherein the scanning device includes a scanning module and a processing unit. The double-side image scanning method is used to determine the image range of the first side of the document through processing a first image signal obtained by scanning the first side of a document, and use the image range thus obtained as the image range of the second side, thus achieving the objective of automatically determining the size of the document to be scanned and the scanning position, and scanning the double sides of a document speedily.

### BACKGROUND

1. Field of Invention

The invention relates a double-side image scanning method and device, that is utilized in a scanner capable of scanning both sides of a document, and determining automatically the image range of the first side, and applying it on the scanning of the second side, as such obtaining its image data and achieving the objective of speedy scanning of the two sides of a document.

2. Related Art

Nowadays, with the progress and development of the computer peripheral hardware equipment, the image input operation of a document or a picture is achieved through the application of an optical scanner, and then the images thus obtained can be displayed, recognized, edited, stored and output on computer monitors or other electronic devices. During the scanning process, the determination of the sizes and ranges of the scanned document is essential. In general, the boundary or the range of the document processed by the scanner is determined through the difference between the background color of the document cover inside of a scanner and the color of the document to be scanned. However, usually, the same series of colors are utilized as the background color of the document to be scanned, thus when the color of the document to be scanned and the background color of the document cover inside of a scanner are getting close, the scanner would mistake the background color of the document cover inside for the color of the document to be scanned, thus resulting in the consequence that the area of the document to be scanned would be misjudged or that the area of the document to be scanned can not be determined at all.

To overcome the above-mentioned drawbacks and shortcomings, a technology of prior art disclosed in the Patent Publication No. 576090 of the Republic of China “Method of determining document range and the corresponding scanner structure”. Refer to FIG. 1 for an explanation of the application of this technology. As shown in FIG. 1, the background color variation layer of the document cover inside 10 is utilized to determine the range of area of document 13 through the comparison of the background color of side portion 11 and that of a document scanning area 12 on the same horizontal level. However, the drawback of this technology is that, when executing the scanning, the scanning module must make comparisons of the colors of side portions 11 and the document scanning area 12 scanned for each of the horizontal levels, thus be able to determine the range of document 13. As such, the signal conversion and determination process is much more complicated, thus it can only used in the single side scanning of a document.

In order to overcome the shortcoming of the prior art just mentioned, another technology is disclosed in the Patent Publication No. 569608 of the Republic of China “Scanning method used in fetching document image of the paper-feeding type scanner”. Refer to FIG. 2 for a description of this technology. As shown in FIG. 2, the characteristic of the application of this type of paper-feeding-type scanner is that, the scanning begins before the document reaches the scanning position, and the scanning continues after the document leaves the scanning position. The scanning area includes the entire scanning window (comprising the background and the document itself), so that the range 20 of the image scanned is larger than that of the document. The light-sensing unit of the scanning module is utilized to sense and obtain the luminance (intensity) of the light, and compare it with a threshold value to distinguish and determine the edge of the document, then the areas of left-right edges 21 and front-rear edges 22 are deleted from the range thus obtained, as such, obtaining the range of the image 23 desired to be scanned, namely the portions of the range of the scanned image that really belongs to the document. Through in this technology, the objective of automatically obtaining the image of the document can be obtained. However, the scanning must be performed to the entire range of window (including the background and the document itself), then the digital signals thus obtained are determined and selected according to a certain criterion to obtain the image of the document. As such, in this process, the signal conversion and determination involved are quite complicated. Besides, this technology can only be applied to one-side scanning of the document.

In the above-mentioned prior art, through the objective of obtaining the image of a document can be obtained, however, it must go through the complicated signal conversion and discrimination processes, moreover, it can only be applied to the single side scanning of the document. Therefore, if both sides of the document have to be scanned, then it must be handled in a single-side scanning manner, wherein, one side of the document is scanned first, then the document must be turned over, thus the single-side scanning can be performed on the other side of the document, so that the single-side scanning must be performed twice to achieve the double-side scanning of a document. As such, the operation process of the scanning is long and complicated, so that not only hardware must be utilized to execute continuously the signals processing and discrimination, but the document must also be turned over manually or by means of an external operation unit in the scanning process, hereby resulting in the lack of efficiency of the entire scanning process.

### SUMMARY OF THE INVENTION

In order to overcome and improve the above-mentioned shortcomings and drawbacks of the prior art, the invention provides a double-side image scanning method and device. In the application of the invention, the document to be scanned is fed into the scanning device automatically through a paper feeding device, then one side of the document to be scanned is scanned by a set of optical devices, so as to determine the size and range of the document, thus automatically determining the range of the image. Then the scanning of the other side of the document is performed by directly utilizing the image range obtained in the scanning just performed previously. As such, in the entire scanning process, since the relative positions of the document and the optical device are fixed and known, so the range determination has to be performed only once to obtain the image range of the document. Thus, the scanning can be performed on both sides of the document to obtain the images of both sides, hereby improving the single-side image scanning technology of the prior art, simplifying the complicated operation procedures in obtaining the image of both sides of a document, and raising the efficiency of document scanning significantly.

To achieve the above-mentioned objective of the automatic double-side image scanning of a document, the invention provides a method of double-side image scanning, including the following steps:
1. Scanning the first side and the second side of a document separately to obtain a first image signal of the first side and a second image signal of the second side;
2. Determining the image range of the first image signal; and
3. Processing the second image signal according to the image range just obtained.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow illustration only, and thus are not limitative of the invention, and wherein:

FIG. 1 is a schematic diagram of the scanner structure used in determining the range of a document according to the prior art;

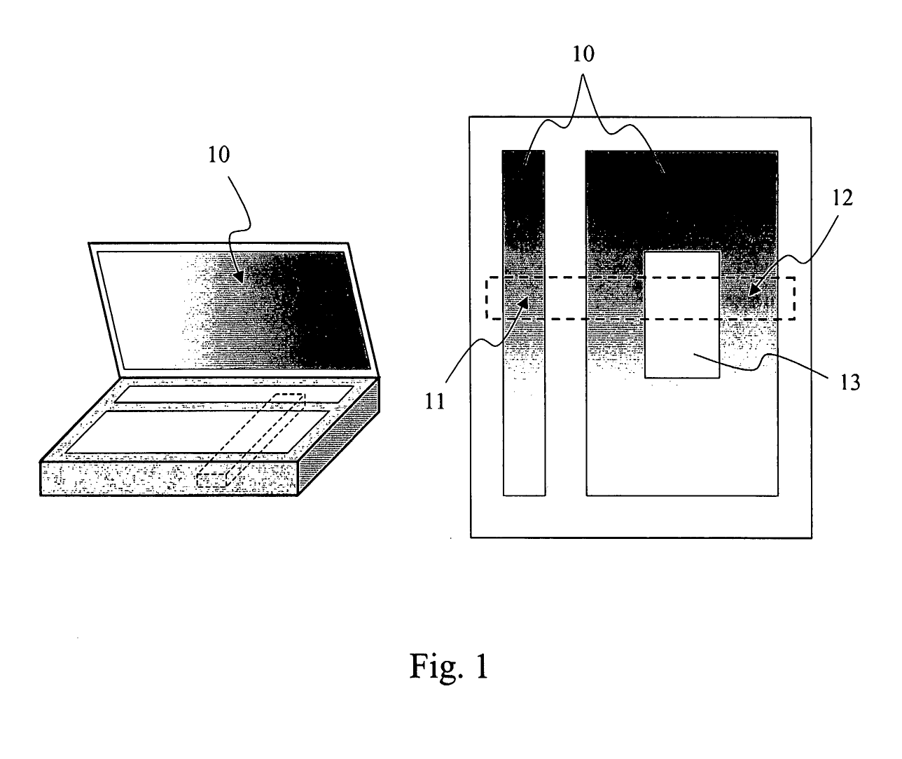

FIG. 2 is a schematic diagram of a scanning window and a scanned document according to the prior art;

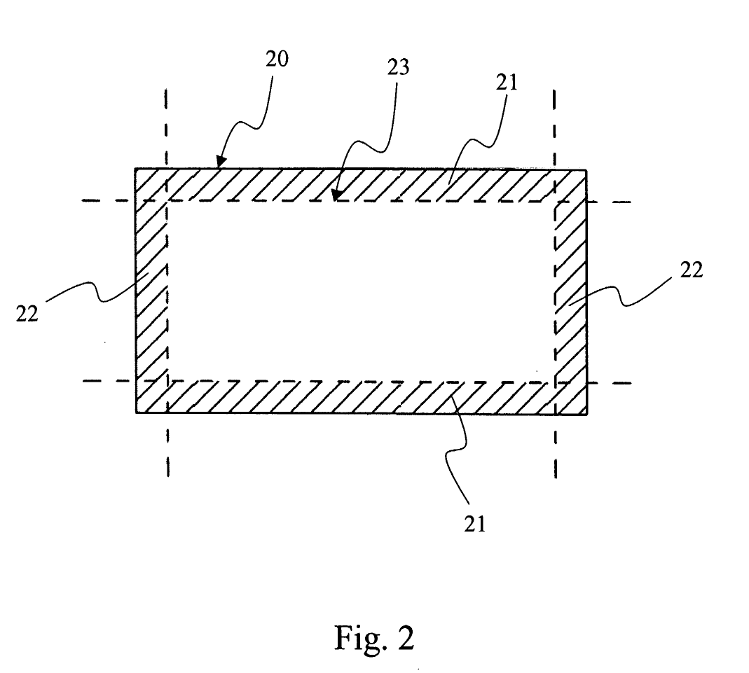

FIG. 3 is a system block diagram of the double-side image scanning device according the invention;

FIG. 4 is a flowchart of the steps of the double-side image scanning method according to a first embodiment of the invention;

FIG. 5 is a flowchart of the steps of the double-side image scanning method according to a second embodiment of the invention;

FIG. 6 is a schematic diagram of the structure of the double-side image scanning device according to the first embodiment of the invention; and

FIG. 7 is a schematic diagram of the structure of the double-side image scanning device according to the second embodiment of the invention.

### DETAILED DESCRIPTION OF THE INVENTION

The purpose, construction, features, and functions of the invention can be appreciated and understood more thoroughly through the following detailed description with reference to the attached drawings.

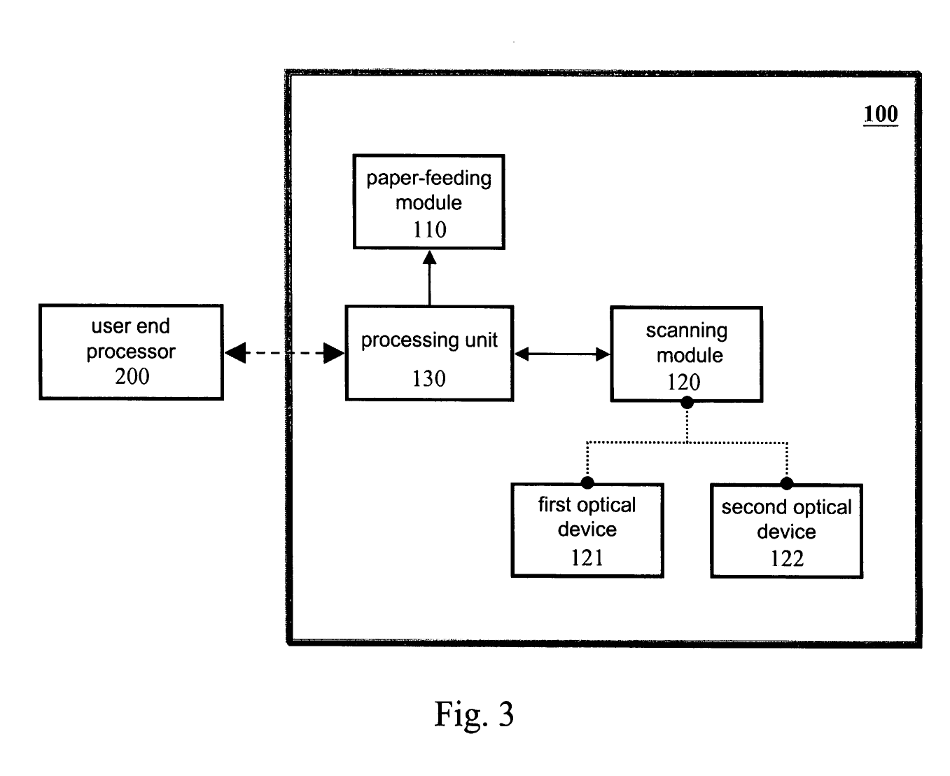

Firstly, refer to FIG. 3 for a system block diagram of a double-side image scanning device according to an embodiment of the invention. As shown in FIG. 3, the double-side image scanning device 100 of the invention includes the following elements:

A scanning module 120, which is used to provide the scanning function, and transmit the image signal to a processing unit 130 to determine an image range; and

A processing unit 130, which is connected to the scanning module 120, and generate the image data according to the image signal obtained by the double-side image scanning device 100 and determine the image range.

In the above structure, the scanning module 120 may further includes: a first optical device 121, which is used to scan the first side of a document P to obtain a first image signal, and transmit the first image signal to the processing unit 130 to generate the image data of the first side of the document P in the image range; and a second optical device 122, which is used to scan the second side of the document P to obtain a second image signal, and transmit it to the processing unit 130 to directly generate the image data of the second side of the document P based on the image range just obtained. In the above description, the first optical device and the second optical device are so disposed that the distance between them is fixed. In addition, the processing unit 130 may be connected to a user end processor 200 to determine the image range by making use of a program stored therein. The double-side image scanning device 100 may further include a paper-feeding module 110, which can be used to feed in the document P automatically to proceed with the scanning function. Moreover, the image range may be a range between the left-side edge and the right-side edge, or a range between the leading edge and the trailing edge, and between the left-side edge and the right-side edge.

As such, through the operation and processing of the processing unit 130, the image range of the first side of the document P can be determined, and thus the image data of the first side of the document P can be obtained. Furthermore, since the distance between the first optical device 121 and the second optical device 122 is fixed and known, such that the image range just obtained may be applied directly to proceed with the scanning of the second side of the document P. Or, alternatively, the processing unit 130 may be connected to a user end processor 200 to determine the image range of the first side of the document P by means of a program stored in that user end processor 200, and obtain the image data of the first side of the document P scanned according to the image range, meanwhile, the image range may be applied directly to proceed with the scanning of the second side of the document P.

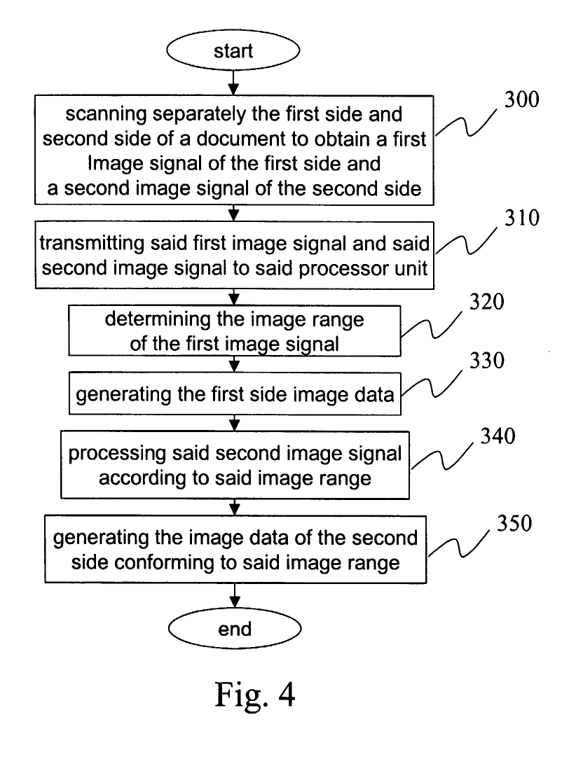

Subsequently, refer to FIG. 4 for a flowchart of the steps of the double-side image scanning method according to a first embodiment of the invention. Firstly, scan the first side and the second side of a document separately to get a first image signal of the first side and a second image signal of the second side by means of a scanning module 120 (step 300), and transmit the first image signal and the second image signal to the processing unit 130 (step 310). Next, determine the image range of the first image signal through the processing unit 130 (step 320), and generate the image data of the first side (step 330). Then, process the second image signal according to the image range (step 340), and generate the image data of the second side conforming to the image range obtained above (step 350). And finally, terminate the double-side image scanning process of the document P.

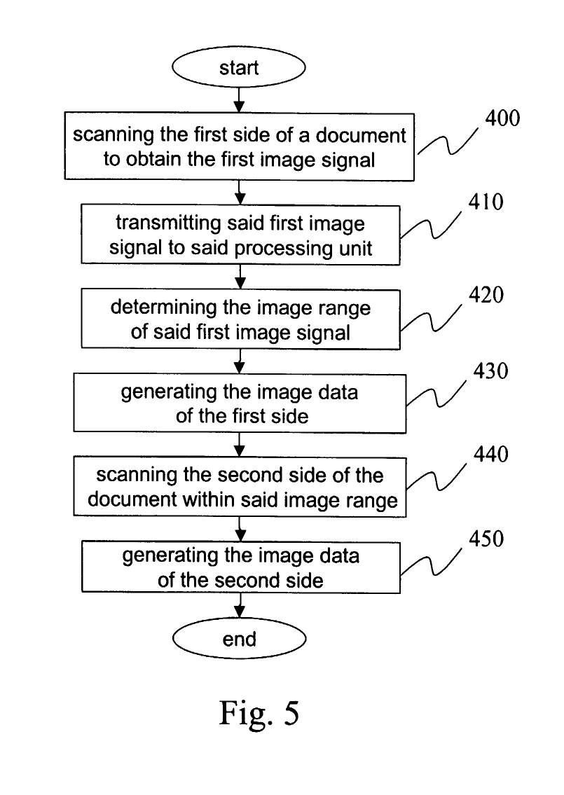

Then, refer to FIG. 5, for a flowchart of the steps of the double-side image scanning method according to a second embodiment of the invention. Firstly, scan the first side of the document P to get a first image signal (step 400), and transmit the first image signal to the processing unit 130 (step 410). Next, determine the image range of the first image signal through the processing unit 130 (step 420), and generate the image data of the first side (step 430). Then, control the scanning module 120 through the processing unit 130 to directly scan the second side of the document P utilizing the image range (step 440), and generate the image data of the second side (step 450). And finally, terminate the double-side image scanning process of the document P.

Through the implementation of the above two embodiments of the invention, the conventional method of image scanning of two sides of a document can be significantly improved, as such instead of executing the image range determination for each of the respective sides of a document P, thus resulting in the waste of system resources and time of repeated determination, in the invention, the image range determination has to be performed only once for one side of the respective pages of a document, and then the image range thus obtained is applied on the scanning of the other side of the document. Therefore, for the respective document having two-side contents to be scanned, the above-mentioned method and device of the invention can be used to perform image range determination for one side of the document, then the image range thus obtained can be applied directly on the scanning of the other side of the document. Thus, the image range determination has to be performed only once for every page of document having two sides to scan. In this manner, in case the user has a stack of a plurality pages of two-side document need to be scanned, the first, third, and fifth pages of the document may utilize the method and device of the invention to determine the respective image ranges after scanned, then the respective image ranges thus obtained may be applied sequentially on the scanning of the second, fourth, and sixth pages of the document, hereby achieving the speedy and efficient scanning the two sides of the respective pages of a document.

In the following description, two preferred embodiments are described in detail to explain the principle of the invention, which is essential in the implementation and realization of the invention.

### FIRST PREFERRED EMBODIMENT

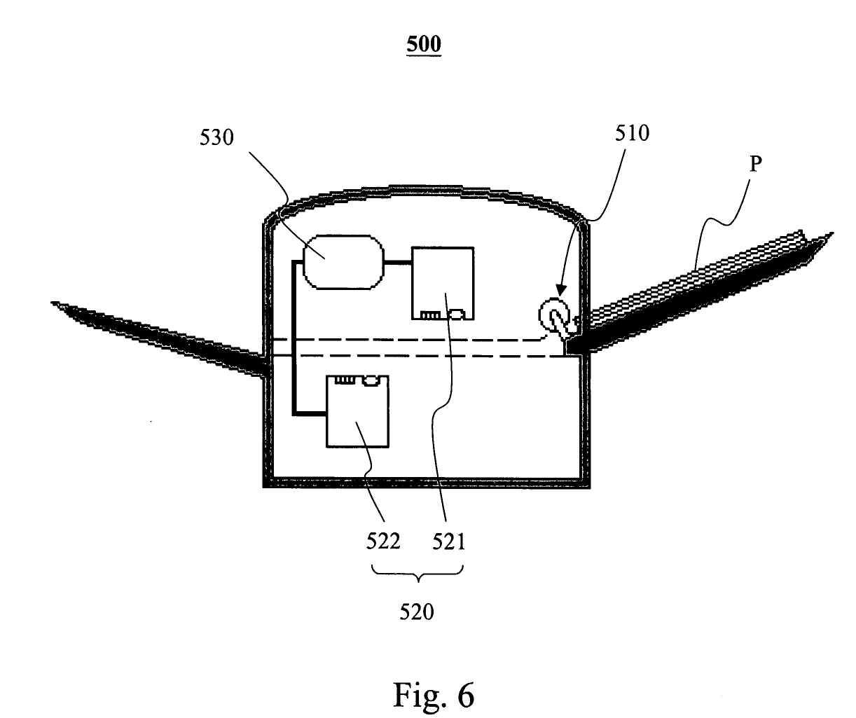

Refer to FIG. 6 for a schematic diagram of the structure of the double-side scanning device according to the first embodiment of the invention. As shown in FIG. 6, the double-side scanning device 500 includes:

A paper-feeding device 510, which is composed of step type motor or any devices having transmission capability, and is capable of automatically feeding document P in cooperation of the scanning speed;

A scanning module 520, which is used to provide the scanning function, and transmit an image signal to a processing unit 530 thus to determine an image range, and execute the scanning function according to the image range, it further includes: a first optical device 521, which is used to scan the first side of the document P, and a second optical device 522, which is used to scan the second side of the document according to the image range determined by the processing unit 530; and

A processing unit 530, which is used to provide the signal calculation and processing among the various devices of the double-side scanning device 500 of the invention, and generate the image data required including the image range.

In the above-mentioned structure, the first optical device 521 of the scanning module 520 is used to scan the first side of the document P, and transmit the first image signal thus obtained to the processing unit 530 to generate the image data conforming to the image range. In addition, the second optical device 522 is used to scan the second side of the document P, it may execute the image scanning by making use of the image range, or it may obtain the image data of the second side directly based on the image range of the first side upon finishing the second side scanning. As such, the image range determination has only to be performed once for one side of the document, and the image range thus obtained may be applied on the scanning of the other side of the document, hereby achieving the speedy and efficient scanning the two sides of the respective pages of a document.

### SECOND PREFERRED EMBODIMENT

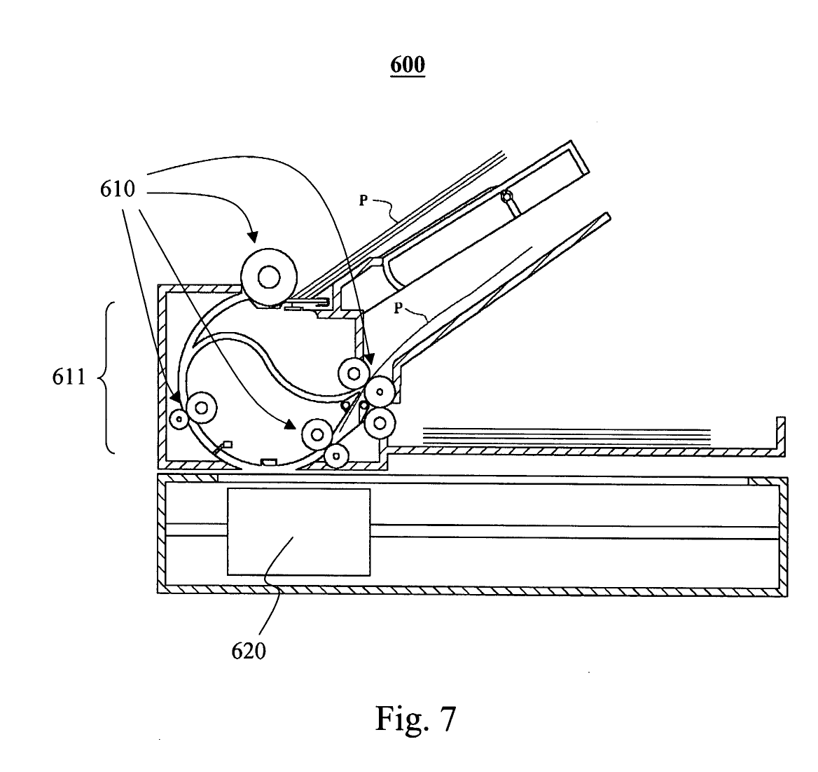

Refer to FIG. 7 for a schematic diagram of the structure of the double-side scanning device according to the second embodiment of the invention. As shown in FIG. 7, the double-side scanning device 600 includes: a paper-feeding device 610, which is used to provide the function of the automatic feeding of the document P; a scanning module 620, which is used to provide the scanning function, and transmit the image signal to a processing unit (not shown) to generate an image data including an image range; a processing unit (not shown), which is used to provide the signal calculation and processing among the various devices of the double-side scanning device 600 of the invention, and generate the image data required. In contrast to the first preferred embodiment, since the scanning module 620 is provided with only an optical device, thus the scanning of the document is realized by the forward feeding and reverse feeding functions of the paper feeding device 610, which is used to turn the document P over by making use of the paper-feeding track 611, hereby realizing the purpose of double-side scanning of a document. Similarly, in this preferred embodiment, the principle of the invention may apply to the scanning device to first process the image signal of the first side of the document P to determine and obtain its image range, then apply it on the scanning of the second side of the document P, namely, scanning the second side of the document P directly by making use of the image range, or it may produce the image data of the second side directly based on the image range of the first side upon finishing the second side scanning. As such, the image range determination has only to be performed once for one side of the document, and the image range thus obtained may be applied on the scanning of the other side of the document, hereby achieving the speedy and efficient scanning the two sides of the respective pages of a document.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A double-side image scanning device, comprising:
a scanning module, used to scan the first side of a document to obtain a first image signal, and scan the second side of a document to obtain a second image signal, and output said first image signal and said second image signal; and
a processing unit, connected to said scanning module, and is used to receive said first image signal and said second image signal, and determine the image range of said first image signal to generate the image data of the first side, and process said second image signal according to said image range, thus generating the image data of the second side having the size of said image range.

2. The double-side image scanning device as claimed in claim 1, wherein said processing unit is used to process said second image signal according to said image range, thus generating the image data of the second side.

3. The double-side image scanning device as claimed in claim 2, wherein said scanning module comprising:
a first optical device, used to scan the first side of said document, and output said first image signal; and
a second optical device, disposed opposite to said first optical device, and is used to scan the second side of said document, and output said second image signal.

4. The double-side image scanning device as claimed in claim 1, wherein said processing unit is used to control said scanning module based on said image range, and scan the second side of said document within said image range to obtain said image data.

5. The double-side image scanning device as claimed in claim 4, wherein said scanning module comprising:
a first optical device, used to scan the first side of said document, and output said first image signal; and
a second optical device, disposed opposite to said first optical device, and is used to scan the second side of said document, and output said second image signal.

6. The double-side image scanning device as claimed in claim 1, wherein the image range is the range of the document between the left-side edge and the right-side edge.

7. The double-side image scanning device as claimed in claim 1, wherein the image range is the range of the document between the leading edge and the trailing edge, and between the left-side edge and the right-side edge.

8. The double-side image scanning device as claimed in claim 1, wherein said processing unit further comprising user end processor, and is used to determine said image range through the operation of a program stored therein.

9. The double-side image scanning device as claimed in claim 1, further comprising a paper-feeding module, which is used to feed said document to pass through said scanning module thus to proceed with the double-side scanning.

10. A double-side image scanning method, comprising at least the following steps:
scanning separately the first side and second side of a document to obtain a first image signal of the first side and a second image signal of the second side;
determining the image range of said first image signal; and
processing said second image signal according to said image range.

11. The double-side image scanning method as claimed in claim 10, wherein the image range is the range of the document between the left-side edge and the right-side edge.

12. The double-side image scanning method as claimed in claim 10, wherein the image range is the range of the document between the leading edge and the trailing edge, and between the left-side edge and the right-side edge.

13. The double-side image scanning method as claimed in claim 10, wherein said step of determining the image range of said first image signal further comprising the step of: generating the image data of the first side.

14. The double-side image scanning method as claimed in claim 10, wherein said step of processing said second image signal according to said image range further comprising the step of: generating the second side image data conforming to said image range.

15. A double-side image scanning method, comprising at least the following steps:
scanning the first side of a document to obtain a first image signal;
determining an image range of said first image signal; and
scanning the second side of said document within said image range.

16. The double-side image scanning method as claimed in claim 15, wherein the image range is the range of the document between the left-side edge and the right-side edge.

17. The double-side image scanning method as claimed in claim 15, wherein the image range is the range of the document between the leading edge and the trailing edge, and between the left-side edge and the right-side edge.

18. The double-side image scanning method as claimed in claim 15, wherein said step of determining the image range of said first image signal further comprising the step of: generating the first side image data.

19. The double-side image scanning method as claimed in claim 15, wherein said step of scanning the second side of said document within said image range further comprising the step of: generating the second side image data.
